(19) United States
(12) Patent Application Publication
(10) Pub. No.: US 2023/0368589 A1
(43) Pub. Date: Nov. 16, 2023

(54) MANAGING AVIATION-ENGINE PERFORMANCE DATA

(71) Applicant: Avco Corporation, Haslet, TX (US)

(72) Inventors: Albert Richard Plytage, Williamsport, PA (US); Benjamin Edwin Sandford, Cogan Station, PA (US); David Martin Reid, Chambersburg, PA (US); Zachary Robert Mihalov, Williamsport, PA (US)

(21) Appl. No.: 18/316,456

(22) Filed: May 12, 2023

Related U.S. Application Data
(60) Provisional application No. 63/341,039, filed on May 12, 2022.

(51) Int. Cl. G07C 5/08; G07C 5/00

(52) U.S. Cl. CPC G07C 5/0808; G07C 5/006; G07C 5/0841

(57) ABSTRACT

A technique provides a field service tool (FST) that allows customers to view and store engine performance data, including faults, in a convenient manner. The technique allows customers to gain insights into performance anomalies while preventing customers from changing engine parameters except for a limited set of parameters selected to avoid the need for service visits while having no effect on safety or compliance.

### CROSS-REFERENCE TO RELATED APPLICATIONS

This application claims the benefit of co-pending U.S. Provisional Application No. 63/341,039, filed May 12, 2022, the contents and teachings of which are incorporated herein by reference in their entirety.

### BACKGROUND

Modern aviation engines include a variety of sensors connected to an engine control unit (ECU). The sensors generate performance data that relate to engine operation. The ECU collects the performance data and takes actions based on such data, such as varying engine settings and raising faults when settings deviate from expected values. A modern aviation engine may also include a data logger, i.e., a device that receives and logs engine data. The data logger typically has a large capacity and can store many minutes or even hours of engine data. The data logger may be connected to the ECU for supporting communications, such as via a controller-area network (CAN) bus.

During engine maintenance and/or repair, an engineer may connect a computer to the ECU (e.g., via a port connected to the CAN bus) and operate an engineering tool to read performance data from the ECU and/or data logger. The engineer may then identify faults, diagnose them, and direct any needed repairs.

### SUMMARY

Unfortunately, engineering tools available for use during engine maintenance and/or repair require specialized expertise that typical customers do not normally possess. As a result, many issues that might readily be addressed by customers instead become reasons for expensive service calls and visits by engineers to customer sites. In addition, aviation engines are subject to strict regulations for ensuring that engines maintain airworthiness and are not subject to tampering. However, engineering tools typically provide much greater access to engine settings than would be safe in the hands of typical customers, who might inadvertently make changes that undermine airworthiness. What is needed, therefore, is a useful and feature-rich customer service tool that can be operated safely by customers without enabling them to change engine settings in a way that could undermine safety, airworthiness, or compliance.

This need is addressed at least in part by a field service tool (FST) that allows customers to view and store engine performance data, including faults, in a convenient manner, allowing customers to gain insights into performance anomalies while preventing customers from changing engine parameters except for a limited set of parameters selected to avoid the need for service visits while having no effect on safety or compliance.

Certain embodiments are directed to a method of facilitating diagnosis of anomalies in an engine of an aircraft. The method includes, while the aircraft is in flight, recording, by an ECU (engine control unit) coupled to the engine, fault data generated in real time by the engine. While the aircraft is not in flight, the method further includes running an FST (field service tool) by a computer coupled to the ECU, the FST including a GUI (graphical user interface) having a set of UI (user interface) controls. In response to a user operation of one or more of the UI controls, the method still further includes (i) uploading the fault data from the ECU to the FST and (ii) generating summary data from the uploaded fault data, the summary data providing a final state of faults described in the fault data.

In some examples, generating the summary data includes, for a particular fault type, consolidating multiple fault messages of the uploaded fault data for the particular fault type into a single fault message that provides the final state of the particular fault type.

In some examples, generating the summary data for the particular fault type includes constructing the single fault message to include: a fault code that identifies the fault; an ECU channel from which the fault originated, as one of a primary channel or a secondary channel; a final fault status of the particular fault type as one of active or inactive; and a lamp indicator that identifies a cockpit lamp that the fault caused to illuminate.

In some examples, constructing the single fault message to include the fault code further includes accessing a database or other file based on the fault code to identify a human-readable description of the fault, and providing the human-readable description of the fault in the single fault message.

In some examples, said one or more of the UI controls includes at least one control for establishing a timespan over which fault messages are uploaded and/or displayed by the FST, said at least one control allowing user selection between (i) an interval of time since an immediately previous engine overhaul and (ii) an interval of time since fault messages in the ECU were last cleared.

In some examples, the GUI of the FST further includes a set of controls for clearing faults stored in the ECU, and the method further comprises (i) the GUI receiving a user operation to clear faults stored in the ECU and (ii) the FST thereafter clearing the faults in the ECU.

In some examples, the method further includes, upon uploading the fault data from the ECU to the FST, automatically storing the uploaded fault data in a log file accessible by the computer, such that no additional user action is required for storing the uploaded fault data in the log file.

In some examples, the method further includes operating the engine while the aircraft is not in flight; receiving, by the FST, real-time data acquired by the ECU from sensors configured to measure parameters of the engine; converting, by the FST, the real-time data from raw units into human-readable engineering units; and displaying, by the GUI, the real-time data in the human-readable engineering units.

In some examples, the method further includes preventing, by the FST, users from changing engine parameters except for a limited set of allowed parameters selected to avoid a need for a service visit while having no effect on safety or compliance.

In some examples, the limited set of allowed parameters includes a setting in the ECU that records a total number of engine hours in which the engine has been in service.

In some examples, the engine has a current total number of engine hours, and the method further includes replacing the ECU with a new ECU and operating the FST to update the total number of engine hours of the new ECU to match the current total number of engine hours of the engine.

In some examples, the limited set of allowed parameters includes a setting in the ECU that records an engine serial number.

In some examples, the engine has a particular engine serial number, and the method further includes replacing the ECU with a new ECU and operating the FST to update a setting in the new ECU that records the engine serial number to match the particular engine serial number of the engine.

In some examples, the method further includes moving the ECU from the engine to a second engine and operating the FST to update the setting in the ECU that records the engine serial number such that the setting matches an engine serial number of the second engine.

In some examples, the limited set of allowed parameters includes a control for resetting an offset of a TPS (throttle position sensor) within the engine.

In some examples, the GUI of the FST displays an amount of time remaining following a TLO (time-limited operation), the TLO being triggered in response to a fault condition in the aircraft that must be addressed within a determined amount of time before the aircraft is deemed non-flightworthy.

Other embodiments are directed to a method operable by a field service tool (FST) that runs on a computer. The method includes connecting the computer to an ECU of an engine and communicating with the ECU to upload performance data stored therein and to prevent customers from changing engine settings except for a limited set of parameters selected to avoid the need for service visits while having no effect on safety or compliance.

Other embodiments are directed to a computerized apparatus constructed and arranged to perform any of the methods described above. Still other embodiments are directed to a computer program product. The computer program product stores instructions which, when executed on control circuitry of a computerized apparatus, cause the computerized apparatus to perform any of the methods described above.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views.

FIG. 1 is a block diagram of an example environment in which embodiments of the improved technique can be practiced.

FIG. 2 is a simplified block diagram of an example environment in which embodiments of the improved technique can be practiced.

FIG. 3 is a screenshot showing an example home screen of a field service tool (FST) of FIGS. 1 and 2.

FIG. 4 is a screenshot showing an example “Retrieve/Clear Faults” screen of the FST.

FIG. 5 is a screenshot showing an example “ECU Active Data” screen of the FST.

FIG. 6 is a screenshot showing an example “Data Logger Unit” screen of the FST.

FIG. 7 is a screenshot showing an example “Info” screen of the FST.

FIG. 8 is a screenshot showing an example graph as generated and displayed by the FST.

FIG. 9 is a flowchart showing an example method that may be conducted using the FST.

### DETAILED DESCRIPTION

Embodiments of the improved technique will now be described. One should appreciate that such embodiments are provided by way of example to illustrate certain features and principles but are not intended to be limiting.

An improved technique provides a field service tool (FST) that allows customers to view and store engine performance data, including faults, in a convenient manner. The FST allows customers to gain insights into performance anomalies while preventing customers from changing engine settings except for a limited set of parameters selected to avoid the need for service visits while having no effect on safety or compliance.

In some examples, the limited set of parameters includes a setting to change engine hours of an engine, i.e., a record of the number of hours in which the engine has been in service. Typically, an engine's ECU stores the number of engine hours such that editing the engine hours requires a write of data to the ECU. Allowing customers to edit engine hours thus allows customers to replace an old ECU with a new ECU without losing track of the actual engine hours accumulated by the engine. Rather, customers can use the FST to edit the engine hours stored in the new ECU to match the actual engine hours of the engine, which normally corresponds to the engine hours reported by the old ECU prior to replacement. Likewise, a customer can move an ECU from one engine to another and ensure that the engine hours reported by that ECU always matches the engine hours of the engine with which it is actually being used. Allowing customers to change engine hours reduces delays, expense, and inconvenience associated with on-site service calls, which might otherwise be needed.

In some examples, the limited set of parameters includes a setting to change an engine serial number, which is normally stored in the ECU. Providing customers with this ability enables customers to install a new ECU into an engine and to update the engine serial number stored in the new ECU to match the serial number of the engine, thus ensuring that the serial number is properly reported while avoiding the need for a service call.

In some examples, the limited set of parameters includes the ability to reset an offset of a TPS (throttle position sensor) within an engine. A TPS outputs a voltage that indicates a location of a throttle butterfly valve. The new feature enables customers to reset the TPS offset, which is used to calibrate the output signal of the TPS so the ECU reports an accurate value. For example, a customer may choose to reset the TPS offset when a mechanic replaces the TPS of the engine. In an example, resetting the TPS offset involves a single mouse click, or a small number of mouse clicks, on a user interface of the FST.

In some examples, the FST provides users with the ability to upload a fault history from the ECU, i.e., a history of fault messages stored in the ECU over an interval of time. In one example, the interval of time corresponds to a TBO (time between overhauls), e.g., such that the uploaded faults include all fault messages accumulated by the ECU since the engine's last overhaul. In another example, the interval corresponds to a service fault history, e.g., such that the uploaded faults include all fault messages accumulated by the ECU since a last time faults in the ECU were cleared. In some examples, users are given the choice to select TBO fault history or service history faults, with the corresponding fault messages uploaded based on user selection.

In some examples, the FST includes a feature for clearing faults from the ECU. For example, a user may clear a service fault history accumulated while experimenting with an engine, e.g., once the experiment is complete and the fault messages are no longer needed. In some examples, the FST enables users to select between clearing the entire TBO fault history or just the most recent service history faults.

According to some examples, uploading fault messages causes those messages automatically to be stored in a log file, e.g., a file on the same computer that runs the FST or on a network file server. No additional user action is required for storing the log file; rather, storage is automatic upon upload. In some examples, the FST displays the name of the log file in which the fault messages are stored, such that users may take note of the file name for later access.

In some examples, the FST renders different tabs for displaying uploaded faults of different kinds. For example, ECUs typically have two redundant channels (primary and secondary), which operate with respective groups of sensors in parallel, such that a failure of a sensor in one channel may be covered (i.e., made up for) by a functioning sensor in the other channel. In an example, the FST includes one tab for displaying fault messages arising from the primary channel and another tab for displaying fault messages arising from the secondary channel.

In some examples, displaying fault messages includes converting encoded information from a native format into corresponding engineering units (e.g., conventional temperature units, RPM units, etc.). In some examples, displaying a fault code in a fault message includes displaying a hexadecimal (“hex”) fault code along with a corresponding human-readable fault description. For example, the FST may display the human-readable description with the corresponding hex code in parentheses. In some examples, the FST may include a database or other file that associates hex fault codes with corresponding descriptions, which may correspond to descriptions listed in a service manual, for example. In this manner, fault messages may be rendered in a user-friendly format that does not normally require customers to access a separate service manual to understand them.

In addition, some examples provide a decoded-faults tab that provides summary information. Fault messages may be numerous and may reflect intermittent conditions such as loose connections or sensors operating near a fault limit. In such cases, it can be difficult for users to determine whether faults are still active, as there are simply too many fault messages to allow a human user to readily track them. To address this difficulty, the decoded-faults tab displays summary information of respective faults. For example, the decoded-faults tab may display each fault type (e.g., for a respective sensor) only once along with a final fault status for the respective fault type. Summary information for each fault type may include a fault code (an identifier of the fault, e.g., fault description with hex code in parentheses), the ECU channel from which the fault originated (e.g., primary or secondary); a fault status (e.g., active or inactive), and/or a lamp (e.g., an identifier of a cockpit lamp, if any, that the associated fault caused to illuminate).

In some examples, fault messages are created in an event-driven manner, e.g., a message is generated when a fault occurs and/or when a fault condition ceases. In some examples, both fault messages and sensor readings include respective values of ECU hours, i.e., the number of service hours of the engine's ECU at the time the fault occurred (or ceased) or when a sensor makes a measurement. The provision of ECU hours allows the FST to correlate events that occur in different parts of an engine based on their time of occurrence, thus facilitating the diagnosis of engine anomalies.

In some examples, the FST displays active data of the engine acquired from the ECU. The active data may include real-time data acquired from sensors. The FST may convert the real-time data from a raw form into engineering units which are easily understood by users.

In some examples, the FST displays an amount of time remaining following a TLO (time-limited operation). A TLO is a type of engine anomaly that presents a sufficient risk such that it must be addressed within a specified amount of time, such as 20 hours. If the amount of time is exceeded without the anomaly being addressed, the engine is deemed not to be airworthy and should be grounded. By displaying the amount of time remaining following a TLO, the FST keeps users informed of how much time remains, e.g., for diagnosis and repair, before the engine is deemed non-airworthy.

In some examples, the FST provides access to performance data of the engine stored in a data logger. For example, the FST enables users to upload runtime data, trip time data, and/or lifetime data stored in the data logger. The FST is configured to store performance data uploaded from the data logger in a local log file, e.g., automatically upon upload and without requiring any separate user action. In an example, runtime data includes engine data logged from the previous flight, such as sensor data from the previous flight sampled at regular intervals, e.g., 1-Hz intervals. Trip-time data may include a statistical summary of logged runtime data from the previous flight, such as minimum, maximum, and/or mean values of the sensor data from the previous flight, e.g., respective sets of statistics for respective sensors. Lifetime data may be similar to trip-time data but may extend over a longer period, such as the entire lifetime of the data logger.

In some examples, the FST stores multiple log files for respective types of data, such as separate log files for TBO faults, service history faults, active data, data logger runtime data, data logger trip-time data, and data logger lifetime data, for example. One log file may be provided for both primary and secondary fault history, or separate log files may be provided for primary fault history and secondary fault history. A separate log file may be provided for storing decoded faults. In some examples, the FST may store and display path information of respective log files, to enable a user to readily access those log files from a local computer. In some examples, the FST renders log files in a spreadsheet-readable format, such as by rendering them in CSV (comma-separated values) format.

According to some examples, the FST provides a graphing feature that enables users to graph selected data, such as sensor data, from a selected log file. For example, the FST may graph information contained in data logger runtime files and/or active (real-time) data that has been uploaded from the ECU. In some examples, the FST provides a set of controls to allow users to select a particular log file. The FST then scans the selected log file to identify multiple sensors having data stored in the selected log file. The FST displays a list of those sensors and allows users to select particular sensors for display from the list. The FST then displays data associated with selected sensors in graphical format, e.g., with different colors used for respective sensors.

Some examples include a method of operating an engine and recording, by an ECU, real-time fault data generated by the engine during operation. The method includes rendering a GUI (graphical user interface) of a field service tool (FST) that runs on a computer. The GUI includes a set of user interface (UI) controls for uploading fault data from the ECU. The method further includes responding to user operation of the set of UI controls by uploading fault data from the ECU to the FST and storing the uploaded fault data in a log file on the computer. The method further includes generating summary data from the fault data in the log file. The summary data provides a final state of faults that appear in the fault data of the log file.

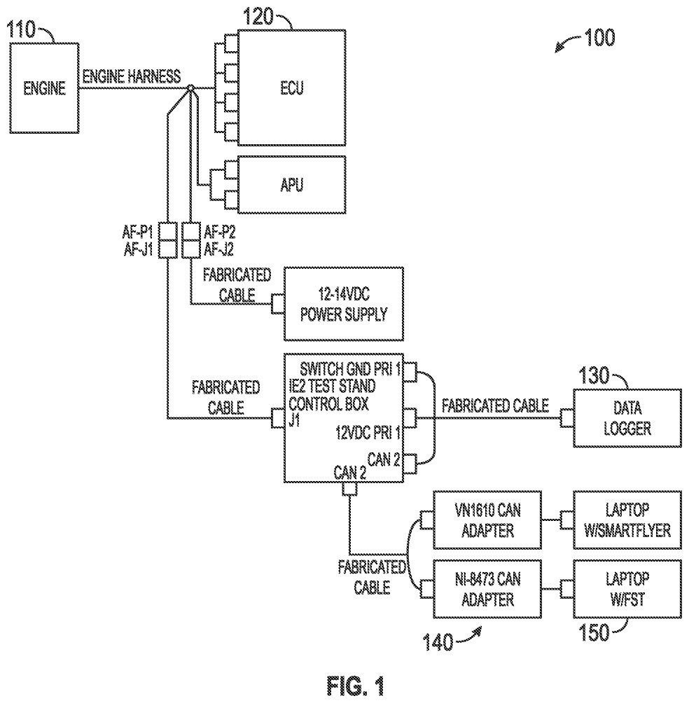

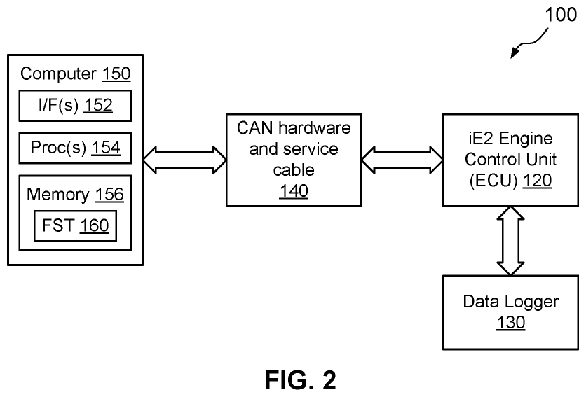

FIGS. 1 and 2 show an example environment 100 in which embodiments of the improved technique can be practiced. The environment 100 may be located at a customer facility, such as an airplane hangar, maintenance shop, repair center, or the like, where engine evaluation, diagnosis, testing, and/or repair may be carried out. Here, an engine 110, such as an aviation engine, connects to an engine control unit (ECU) 120 through various cables. The ECU 120 may be connected to a separate data logger 130. A laptop or other computer 150 (e.g., desktop computer, tablet, smart phone, workstation, etc.) is connected to the ECU 120 via a USB-to-CAN adapter and associated cabling 140. The computer 150 has a field service tool (FST) 160 installed thereon. Alternatively, the computer 150 may access the FST 160 remotely, e.g., as a web application. As shown, the computer 150 includes one or more interfaces 152 (e.g., USB connectors), a set of processors 154, and memory 156 in which the FST 160 is installed or otherwise run. In some examples, the engine 110 is the iE2 Integrated Electronics Engine available from Lycoming Aircraft, a division of AVCO Corporation of Haslet, Texas. However, embodiments are not limited to the iE2 or to any type of engine.

In example operation, an aviation engine 110 is connected, via the interface 140, to the computer 150. The FST 160 runs on the computer 150 and engages in a handshaking protocol with the ECU 120. Upon successful handshaking, a communication session is established between the computer 150 and the ECU 120. While the engine 110 runs, various sensors of the engine 110 measure performance data of the engine, such as temperatures, pressures, speeds, and other parameters. The ECU 120 collects the performance data and checks the data against acceptable limits. If any measurement falls outside of limits, the ECU 120 may generate a fault message. Fault messages are also considered herein to be a type of performance data. The ECU 120 may store accumulated fault messages. Also, the ECU 120 may direct the data logger 130 to store performance data received by the ECU 120 from the various sensors.

In accordance with improvements hereof, the FST 160 may upload performance data, including fault messages, from the ECU 120 to the computer 150, where the performance data may be displayed. The FST 160 may present a GUI (graphical user interface) that allows users to operate user-interface (UI) controls to perform various actions. Such actions may include, for example, uploading and displaying performance data from the ECU 120 and/or from the data logger 130, storing performance data in log files on the computer 150, analyzing the performance data, and graphing the performance data. Actions may further include accepting changes in a limited set of engine parameters, such as engine hours and engine serial number, and writing updated parameters in the ECU 120.

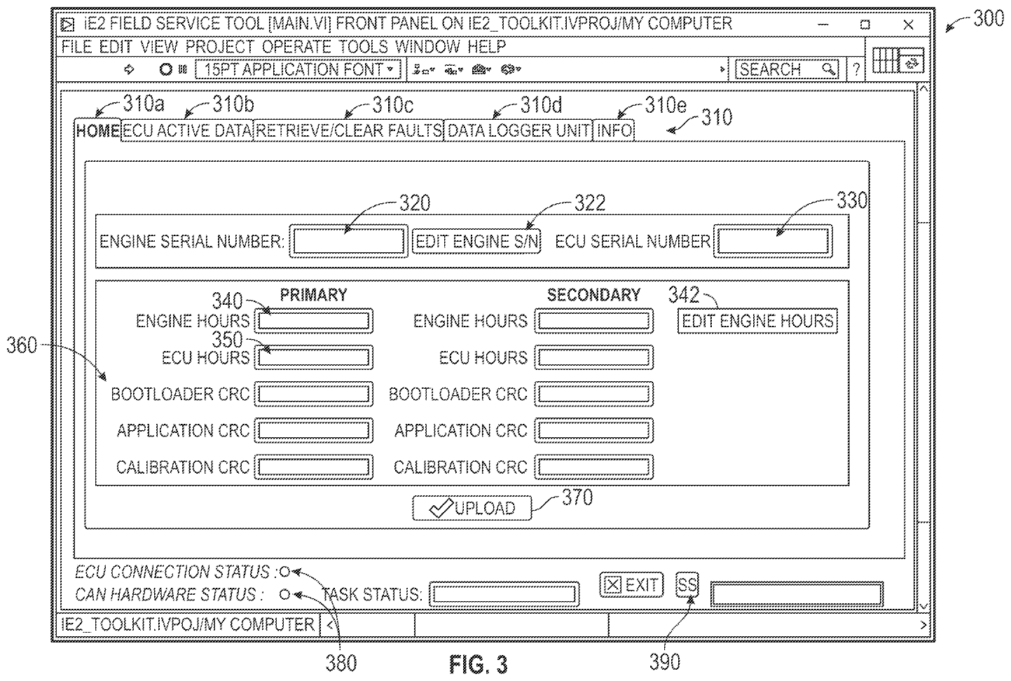

FIGS. 3-8 show various screenshots of the FST 160 and depict examples of a GUI of the FST 160. As shown, the FST 160 may support multiple screens, which may be implemented in respective tabs 310 (e.g., tabs 310a through 310e). The tabs 310 may include, for example,
A “Home” tab 310a;
An “ECU Active Data” tab 310b;
A “Retrieve/Clear Faults” tab 310c;
A “Data Logger Unit” tab 310d; and
An “Info” tab 310e.

These are merely examples of suitable tabs and are not intended to be limiting. Each of the tabs 310, when selected, displays a respective screen that includes respective sets of UI controls or other fields.

FIG. 3 shows a home screen 300, which may be displayed when a user selects the home tab 310a. Here, users can view the engine serial number 320 of the engine 110 and the ECU serial number 320 of the ECU 120. Information about primary and secondary channels of the ECU 110 are displayed in left and right columns of the screen, with each column including engine hours 340, ECU hours 350, and various CRC (cyclic redundancy check) values 360 of the respective channels, such as a bootloader CRC, an application CRC, and a calibration CRC. The CRC values 160 may be checked against published values to confirm data integrity and airworthiness of the engine 110. Any deviation of the CRC values 360 from published values may result in the engine 310 being deemed non-airworthy.

Tab 310a also supports changes in a limited set of engine parameters, e.g., those selected to avoid the need for service visits while having no effect on safety or compliance. For example, a user may edit the engine serial number by clicking button 322, whereupon the user is prompted to enter a new engine serial number to be stored by the ECU 110. A user may also edit the engine hours 340 (primary or secondary) by clicking the button 342 and entering the desired engine hours. Preferably, no other engine parameters besides this limited set may be edited by users.

An upload button 370, when clicked by a user, causes the FST 160 to gather information from the ECU 120 and to populate the depicted fields with corresponding values.

As further shown in FIG. 3, status indicators 380 are provided to indicate ECU connection status and CAN hardware status. The indicators may illuminate green, for example, when connections are confirmed and when handshaking protocols are successful.

An SS button 390 may be provided to enable the user to take a persistent screenshot of the current screen. For example, clicking the SS button 390 captures a graphical image of the screen, including images of any values displayed in the fields of the screen. In some examples, any screenshot captured by clicking the SS button 390 is saved to a specified directory on the computer 150. In some examples, the indicators 380 and SS button 390 are provided on multiple screens of the FST 160, regardless of the selected tab 310.

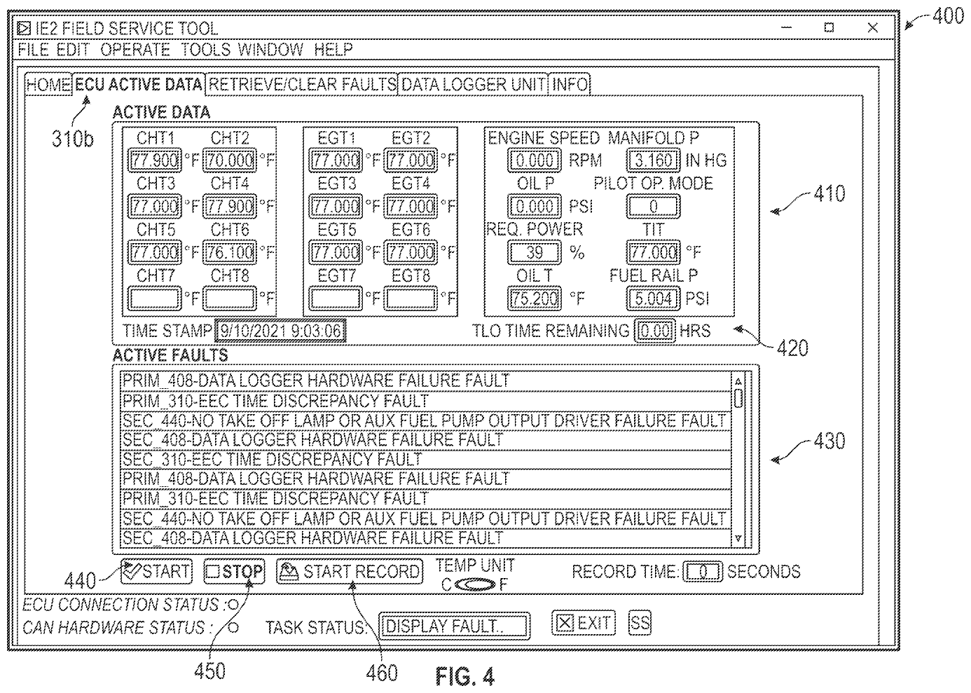

FIG. 4 shows an example screen 400 displayed by the “ECU Active Data” tab 310b. As shown, the screen 400 includes a region 410 that displays real-time active data from the engine 120, i.e., data collected by the ECU 120 from sensors of the engine 110 and uploaded to the FST 160. In an example, the FST 160 converts the real-time active data from a raw form into engineering units which are easily understood by users.

As further shown in FIG. 4, the screen 400 displays a reading 420 of TLO time remaining. This reading 420 indicates an amount of time remaining until the engine 110 is deemed non-airworthy following a TLO (time-limited operation). In an example, the ECU 120 is configured to raise a TLO in response to a detected engine anomaly. A TLO is generally associated with one or more dashboard lamps that may illuminate in an airplane's cockpit. In an example, the TLO reading 420 may have an initial value of 20 hours (the TLO time limit) and may start counting down immediately after detecting a TLO. Reading 420 thus provides a very useful measure of the time remaining before the engine should be grounded.

Screen 400 may further include an active faults window 430, which provides a real-time stream of fault messages from the ECU. These may include messages indicating transitions from a non-fault condition to a fault condition, as well as transitions from a fault condition to a non-fault condition.

Using UI controls 440, 450, and 460, a user may respectively start, stop, and/or record active faults (from window 430) and active data (from window 410). Such results may be stored in one or more specified log files.

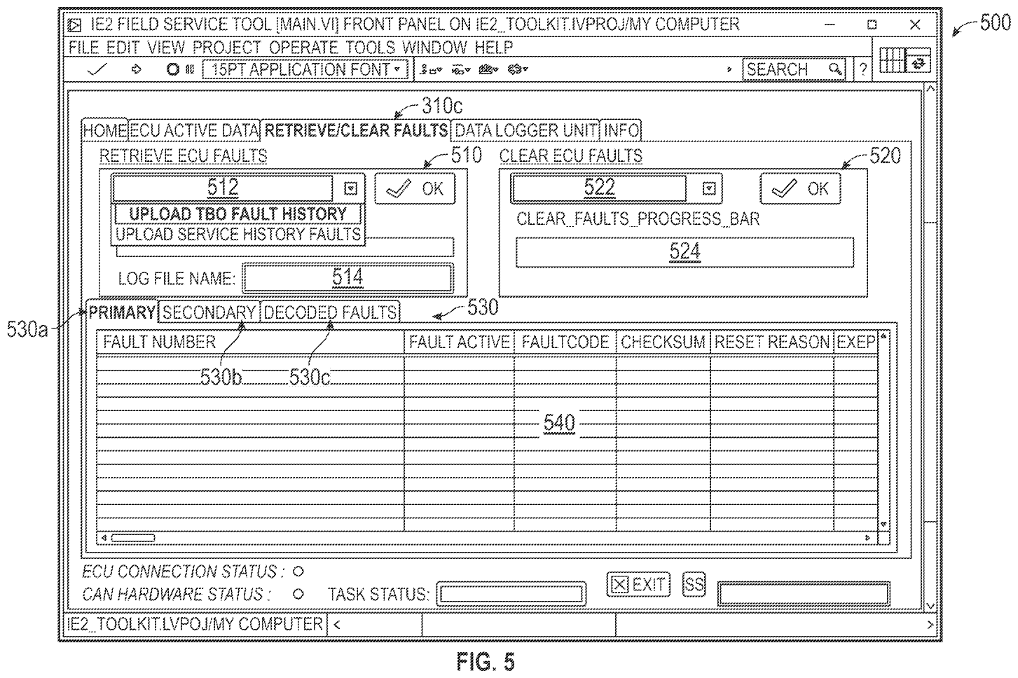

FIG. 5 shows an example screen 500 that may be displayed by clicking the “Retrieve/Clear Faults” tab 310c. As shown, the screen 500 includes regions 510, 520, and 540.

Region 510 includes UI controls for retrieving faults from the ECU 120. UI control 512 allows users to select between TBO fault history (faults accumulated since the last engine overhaul) and as service history faults (faults accumulated since the last time faults were cleared). In some examples, uploading fault messages causes those messages automatically to be stored in a log file, e.g., a file on the computer 150. In an example, no additional user action is required for storing the log file; rather, storage is automatic upon upload. In some examples, a field 514 displays the name of the log file in which the uploaded fault messages are stored, such that users may take note of the file name for later access.

Region 520 includes UI controls for clearing faults from the ECU 120. For example, a user may operate UI control 522 to select a fault history to be cleared. Progress bar 524 displays progress toward deleting the selected faults from the ECU 120. In some examples, one of the options presented when clicking the UI control 522 is an option to reset the TPS (throttle position sensor) offset. For example, control 522 is provided as a pull-down list and there is a selectable item in the pull-down list to “Reset TPS Offset.” The operator can click “ok” next to that option to reset the TPS Offset value.

Region 540 is provided for the display of uploaded fault messages. In some examples, different tabs 530 are provided for displaying uploaded faults of different kinds. For example, the tabs 530 include a “Primary” tab 530a, a “Secondary” tab 530b, and a “Decoded Faults” tab 530c. As previously mentioned, the ECU 120 may have two redundant channels (primary and secondary), which operate with respective groups of sensors in parallel, such that a failure of a sensor in one channel may be covered (made up for) by a functioning sensor in the other channel. In an example, the tab 530a displays fault messages arising from the primary channel and the tab 530b displays fault messages arising from the secondary channel. Displaying fault messages may include converting encoded information from a native format into corresponding engineering units (e.g., conventional temperature units, RPM units, etc.). In some examples, displaying a fault code in a fault message includes displaying a hexadecimal (“hex”) fault code along with a corresponding human-readable fault description. For example, the FST 160 may display the human-readable description with the corresponding hex code in parentheses. The FST 160 may include a database or other file that associates hex fault codes with corresponding descriptions, which may correspond to descriptions listed in a service manual, for example. In this manner, fault messages may be rendered in a user-friendly format that does not require customers to access a separate service manual to understand them.

The “Decoded Faults” tab 530c provides summary information of fault messages provided in the Primary tab 530a and/or in the Secondary tab 530b. Fault messages may be numerous and may reflect intermittent conditions such as loose connections or sensors operating near a fault limit, such that it can be difficult for users to determine whether faults are still active. To address this difficulty, the Decoded Faults tab 530c displays summary information of respective faults. For example, the decoded-faults tab 530c displays each fault type (e.g., for a respective sensor) only once, along with a final fault status for the respective fault type. Summary information for each fault type may include, for example, a fault code (an identifier of the fault, e.g., fault description with hex code in parentheses), the ECU channel from which the fault originated (e.g., primary or secondary); a fault status (e.g., active or inactive), and/or a lamp (e.g., an identifier of a cockpit lamp (if any) that the associated fault caused to illuminate.

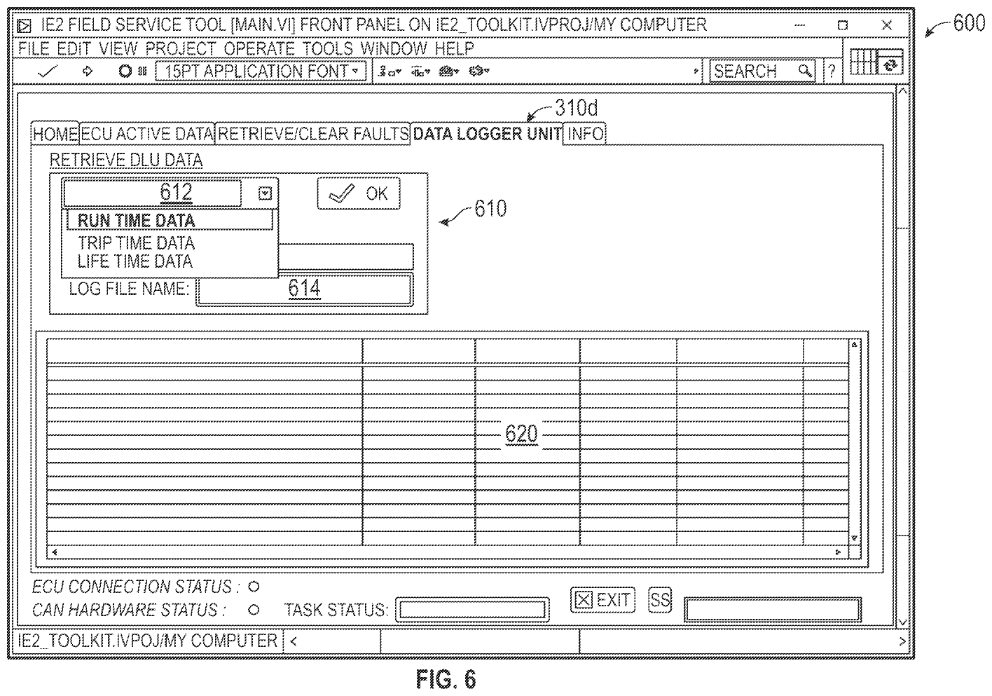

FIG. 6 shows an example screen 600 that may be displayed by clicking the “Data Logger Unit” tab 310d. As shown, the screen 600 includes regions 610 and 620. Region 610 specifies performance data to be retrieved from the data logger 130, and region 620 displays the retrieved data.

As shown in region 610, data selected for upload from the data logger 130 may include a control 612 that allows users to select a type of data to be uploaded. The available options may include runtime data, trip time data, and/or lifetime data, for example. The runtime data includes engine data logged from the previous flight, such as sensor data from the previous flight sampled at regular intervals, e.g., 1-Hz intervals. The trip-time data includes a statistical summary of logged runtime data from the previous flight, such as minimum, maximum, and/or mean values of the sensor data from the previous flight. For example, respective sets of statistics may be provided for respective sensors. The lifetime data may be similar to the trip-time data but may extend over a longer period, such as the entire lifetime of the data logger 130. As before, any data retrieved is automatically stored in a specified log file on the computer 150, e.g., without requiring any specific action from the user to save or store the data. A field 614 may be provided for displaying the name of the log file that stores the uploaded data.

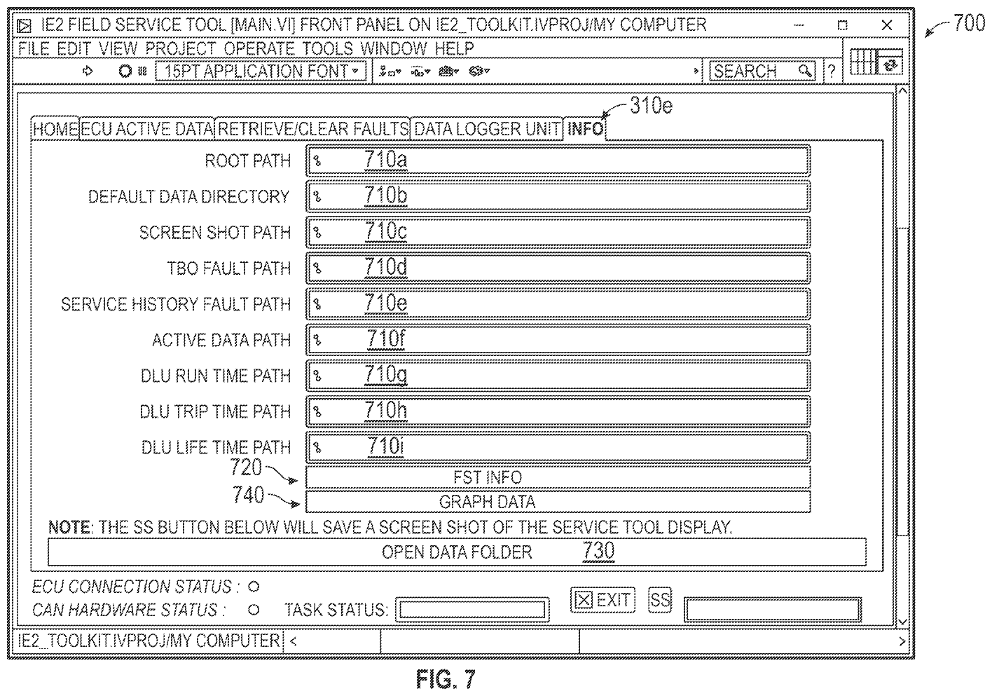

FIG. 7 shows an example screen 700 that may be displayed by clicking the “Info” tab 310e. As shown, the screen 700 displays locations 710a through 710e of various log files on the computer 150, such as path information for providing locations of log files in a file system of the computer 150. These may include, for example, locations of separate log files for TBO faults, service history faults, active data, data logger runtime data, data logger trip-time data, and data logger lifetime data, for example.

A button 720 may be clicked to display FST Info, such as version and copyright information. A button 730 may be clicked to open a selected data folder. A button 740 may be clicked to graph data from a data file.

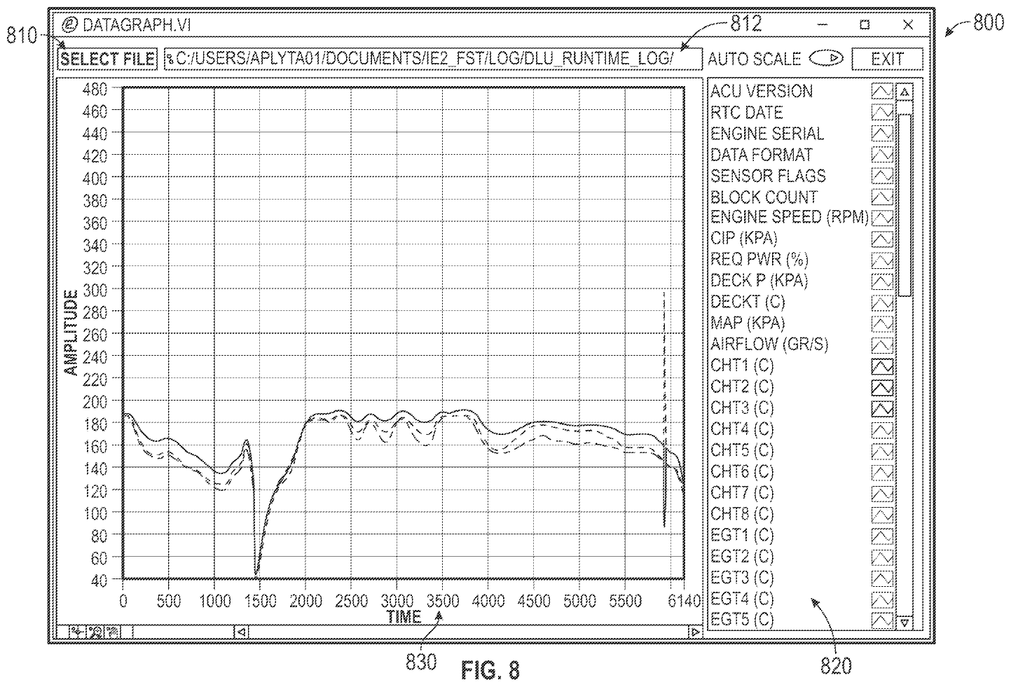

FIG. 8 shows an example graph 800, such as one that may be displayed by the FST 160 in response to the user clicking the button 740 on the screen 700. As shown, a button 810 allows a user to select a desired log file, e.g., one that contains timestamped sensor data (e.g., ECU Active Data uploaded from the ECU 120 or Runtime Data uploaded from the data logger 130). Field 812 indicates the path of the selected log file.

Region 820 lists variables of the selected log file that are available for graphing. For example, the FST 160 reads the selected log file and identifies therefrom sensors or other variables associated with timestamped performance data. The user may select any desired variables from the list, and the FST 160 displays graphs of the selected variables in region 830, e.g., in a color-coded manner.

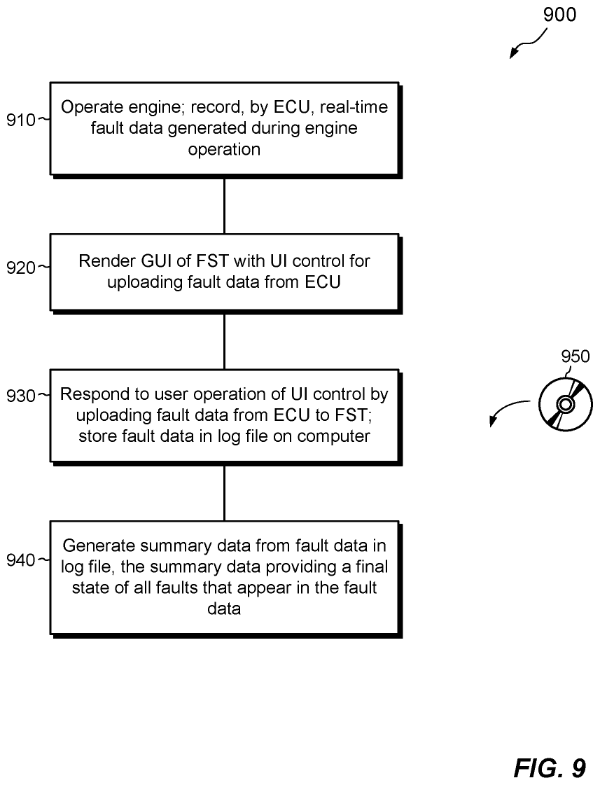

FIG. 9 shows an example method 900 that may be carried out in the environment 100, e.g., at least in part by software constructs of the FST 160 that support functionality for generating decoded faults when rendering the screen 500 shown in FIG. 5. The depicted acts 910, 920, 930, and 940 may be carried out in any order, including performing some acts simultaneously. One should appreciate that various algorithms may be employed for generating decoded faults. In one example, an algorithm searches all faults listed in the primary and secondary tabs 530a and 530b and locates the last instance of each fault type listed and its final state. The algorithm may output a log entry for each fault type. In an example, each log entry provides a fault code (an identifier of the fault), the ECU channel (primary or secondary) from which the fault originated (e.g., fault description with hex code in parentheses); a fault status (e.g., active or inactive), and/or a lamp (e.g., an identifier of a cockpit lamp (if any) that the associated fault caused to illuminate).

Having described certain embodiments, numerous alternative embodiments or variations can be made. Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as medium 950 in FIG. 9). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of facilitating diagnosis of anomalies in an engine of an aircraft, comprising:
while the aircraft is in flight, recording, by an ECU (engine control unit) coupled to the engine, fault data generated in real time by the engine;
while the aircraft is not in flight, running an FST (field service tool) by a computer coupled to the ECU, the FST including a GUI (graphical user interface) having a set of UI (user interface) controls; and
in response to a user operation of one or more of the UI controls, (i) uploading the fault data from the ECU to the FST and (ii) generating summary data from the uploaded fault data, the summary data providing a final state of faults described in the fault data.

2. The method of claim 1, wherein generating the summary data includes, for a particular fault type, consolidating multiple fault messages of the uploaded fault data for the particular fault type into a single fault message that provides the final state of the particular fault type.

3. The method of claim 2, wherein generating the summary data for the particular fault type includes constructing the single fault message to include:
a fault code that identifies the fault;
an ECU channel from which the fault originated, as one of a primary channel or a secondary channel;
a final fault status of the particular fault type as one of active or inactive; and
a lamp indicator that identifies a cockpit lamp that the fault caused to illuminate.

4. The method of claim 3, wherein constructing the single fault message to include the fault code further includes:
accessing a database or other file based on the fault code to identify a human-readable description of the fault; and
providing the human-readable description of the fault in the single fault message.

5. The method of claim 2, wherein said one or more of the UI controls includes at least one control for establishing a timespan over which fault messages are uploaded and/or displayed by the FST, said at least one control allowing user selection between (i) an interval of time since an immediately previous engine overhaul and (ii) an interval of time since fault messages in the ECU were last cleared.

6. The method of claim 2, wherein the GUI of the FST further includes a set of controls for clearing faults stored in the ECU, and wherein the method further comprises (i) the GUI receiving a user operation to clear faults stored in the ECU and (ii) the FST thereafter clearing the faults in the ECU.

7. The method of claim 2, further comprising, upon uploading the fault data from the ECU to the FST, automatically storing the uploaded fault data in a log file accessible by the computer, such that no additional user action is required for storing the uploaded fault data in the log file.

8. The method of claim 2, further comprising:
operating the engine while the aircraft is not in flight;
receiving, by the FST, real-time data acquired by the ECU from sensors configured to measure parameters of the engine;
converting, by the FST, the real-time data from raw units into human-readable engineering units; and
displaying, by the GUI, the real-time data in the human-readable engineering units.

9. The method of claim 2, further comprising preventing, by the FST, users from changing engine parameters except for a limited set of allowed parameters selected to avoid a need for a service visit while having no effect on safety or compliance.

10. The method of claim 9, wherein the limited set of allowed parameters includes a setting in the ECU that records a total number of engine hours in which the engine has been in service.

11. The method of claim 10, wherein the engine has a current total number of engine hours, and wherein the method further comprises:
replacing the ECU with a new ECU; and
operating the FST to update the total number of engine hours of the new ECU to match the current total number of engine hours of the engine.

12. The method of claim 9, wherein the limited set of allowed parameters includes a setting in the ECU that records an engine serial number.

13. The method of claim 12, wherein the engine has a particular engine serial number, and wherein the method further comprises:
replacing the ECU with a new ECU; and
operating the FST to update a setting in the new ECU that records the engine serial number to match the particular engine serial number of the engine.

14. The method of claim 12, further comprising:
moving the ECU from the engine to a second engine; and
operating the FST to update the setting in the ECU that records the engine serial number such that the setting matches an engine serial number of the second engine.

15. The method of claim 9, wherein the limited set of allowed parameters includes a control for resetting an offset of a TPS (throttle position sensor) within the engine.

16. The method of claim 2, wherein the GUI of the FST displays an amount of time remaining following a TLO (time-limited operation), the TLO being triggered in response to a fault condition in the aircraft that must be addressed within a determined amount of time before the aircraft is deemed non-flightworthy.

17. A computer program product including a set of non-transitory, computer-readable media having instructions which, when executed by control circuitry of a computerized apparatus, cause the computerized apparatus to perform a method of facilitating diagnosis of anomalies in an engine of an aircraft, the method comprising:
running an FST (field service tool), the FST including a GUI (graphical user interface) having a set of UI (user interface) controls, the ECU coupled to the engine and configured to record fault data generated in real time by the engine; and
in response to a user operation of one or more of the UI controls, (i) uploading the fault data from the ECU to the FST and (ii) generating summary data from the uploaded fault data, the summary data providing a final state of faults described in the fault data.

18. The computer program product of claim 17, wherein the method further comprises preventing, by the FST, users from changing engine parameters except for a limited set of allowed parameters selected to avoid a need for a service visit while having no effect on safety or compliance.

19. The computer program product of claim 18, wherein the limited set of allowed parameters includes a setting in the ECU that records a total number of engine hours in which the engine has been in service.

20. The computer program product of claim 19, wherein the limited set of allowed parameters includes a setting in the ECU that records an engine serial number.
